(19) United States
(12) Patent Application Publication
(10) Pub. No.: US 2025/0389364 A1
(43) Pub. Date: Dec. 25, 2025

(54) REPAIR CLAMP TIGHTENING BOLT ASSEMBLY

(71) Applicant: DRESSER TPS, LLC, Houston, TX (US)

(72) Inventors: Daryl M. Piontek, Great Valley, NY (US); Richard Fontes, Allegany, NY (US); John Tuttle, Olean, NY (US)

(21) Appl. No.: 18/880,685

(22) PCT Filed: Jul. 5, 2023
(86) PCT No.: PCT/US2023/026901

§ 371 Date: Jan. 2, 2025

Related U.S. Application Data
(60) Provisional application No. 63/358,991, filed on Jul. 7, 2022.

(51) Int. Cl. F16L 55/172; F16L 55/178

(52) U.S. Cl. CPC F16L 55/172; F16L 55/178

(57) ABSTRACT

A clamp comprising a band having first and second edges, a connection assembly operatively configured to tighten the band to a fluid conduit from a non-actuated position to a tightened position and the connection assembly having first and second lug elements attached proximate to the first and second band edges and first and second lug bolts extending transversely between the first and second lug elements, and a handle extending longitudinally between the first and second lug bolts.

### TECHNICAL FIELD

The present invention relates generally to the field of repair clamps, and more particularly to an improved repair clamp tightening assembly.

### BACKGROUND ART

Repair clamps are used in the placement of pipes or for connecting the ends of pipes axially. Such clamps generally have a cylindrical body or band which encircles the subject pipe or pipe ends. Two opposed lugs are attached to the opposed edges of the cylindrically-shaped band, and the lugs are drawn towards each other by tightening bolts or fasteners. This reduces the affective internal diameter of the band, which in turn compresses an elastomeric sheet gasket that is typically placed between the band and the subject pipe. Compressing the gasket sheet seals the gasket to the pipe. To bridge the gap that is formed between the ends of the band, a spanner or bridge plate molded into or placed onto the outer surface of the gasket is employed to provide gasket compression across the gap. The spanner plate fits on the outer surface of the elastomeric sheet gasket and is compressed radially inward by the lugs along the opposed edges of the cylindrical band. The lug pairs have projecting fingers with corresponding matching opposing finger contact lands that place the finger to land contact surfaces parallel to the finger motion direction and parallel to the axis of the tightening bolts of the system.

### BRIEF SUMMARY

With parenthetical reference to corresponding parts, portions or surfaces of the disclosed embodiment, merely for the purposes of illustration and not by way of limitation, an improved clamp assembly (15) is provided comprising: a band (16) configured to clamp on to a fluid conduit (17) oriented about a longitudinally extending axis (x-x); the band comprising a first longitudinally extending edge (19) and a second longitudinally extending edge (20); a connecting assembly (21) operatively configured to tighten the band to the fluid conduit from a non-actuated position to a tightened position; the connecting assembly comprising a first lug element (22) connected proximate to the first longitudinally extending edge of the band and a second lug element (23) connected proximate to the second longitudinally extending edge of the band; the first lug element comprising multiple longitudinally spaced bolt receiving openings (24a, 24b); the second lug element comprising multiple longitudinally spaced bolt receiving openings (25a, 25b); multiple lug bolts (26a, 26b) extending transversely between the first lug element and the second lug element, each of the lug bolts orientated about a central bolt axis (28a, 28b) and extending from one of the bolt receiving openings in the first lug element to one of the bolt receiving openings in the second lug element; and a handle (43) extending longitudinally between at least two of the transversely extending lug bolts.

The multiple lug bolts may comprise a first lug bolt (26a) having a first head portion (67a) and a first shank portion (64a), and a second lug bolt (26b) having a second head portion (67b) and a second shank portion (64b). The handle may extend from the first head portion of the first lug bolt to the second head portion of the second lug bolt. The handle may extend from the first head portion of the first lug bolt at a first angle (47a) offset from a first central axis (28a) of the first lug bolt and may extend from the second head portion of the second lug bolt at a second angle (47b) offset from a second central axis (28b) of the second lug bolt. The handle may be connected to the first head portion of the first lug bolt via a weld connection or a mechanical connection. The handle may be connected to the second head portion of the second lug bolt via a weld connection or a mechanical connection. The handle may be welded to the first head portion of the first lug bolt and the second head portion of the second lug bolt. The handle may comprise a longitudinally extending rod portion (45).

The bolt receiving openings in the first lug element may comprise an open slot (24a, 24b) and the bolt receiving openings in the second lug element may comprise a cylindrical through-bore (25a, 25b). The first lug element may comprise multiple longitudinally spaced and transversely extending lug fingers (29a, 29b); the second lug element may comprise multiple longitudinally spaced lug finger lands (31a, 31b); and each of the lug fingers of the first lug element may extend transversely between the first lug element and the second lug element such that each of the lug fingers of the first lug element bear against one of the lug finger lands of the second lug element. The second lug element may comprise multiple longitudinally spaced and transversely extending lug fingers (39a, 39b); the first lug element may comprise multiple longitudinally spaced lug finger lands (41a, 41b); and each of the lug fingers of the second lug element may extend transversely between the second lug element and the first lug element such that each of the lug fingers of the second lug element bear against one of the lug finger lands of the first lug element.

The first lug element may be connected to the band proximate to the first longitudinally extending edge of the band via a weld connection or a mechanical connection and the second lug element may be connected to the band proximate to the second longitudinally extending edge of the band via a weld connection or a mechanical connection.

### BRIEF DESCRIPTION OF THE DRAWINGS

FIG. 1 is an isometric view of an embodiment of the improved repair clamp assembly.

FIG. 2 is a right isometric view of the repair clamp assembly shown in FIG. 1 installed on a pipe.

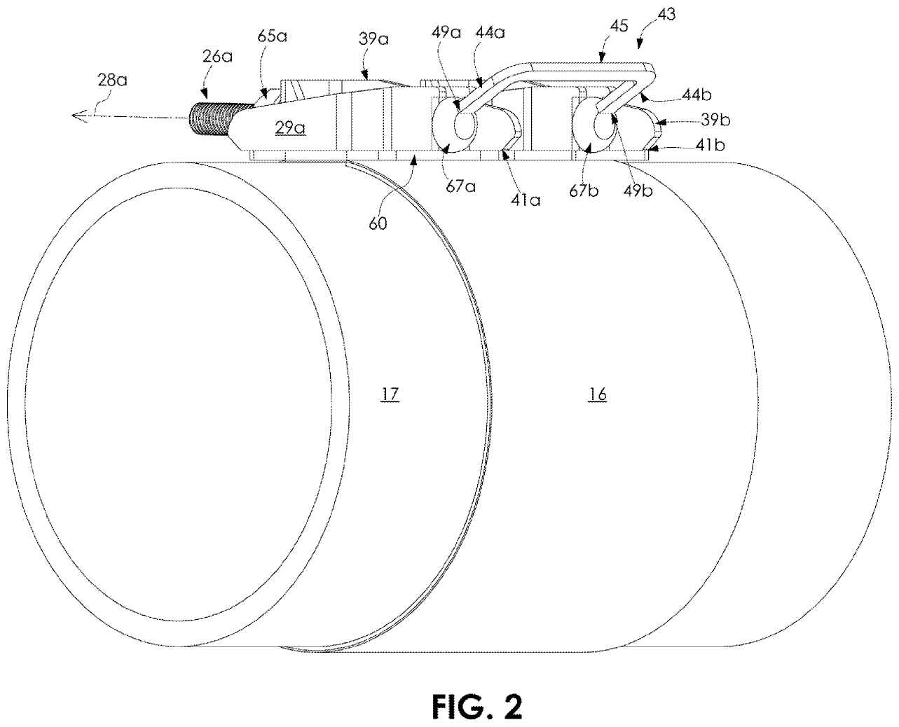

### DETAILED DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

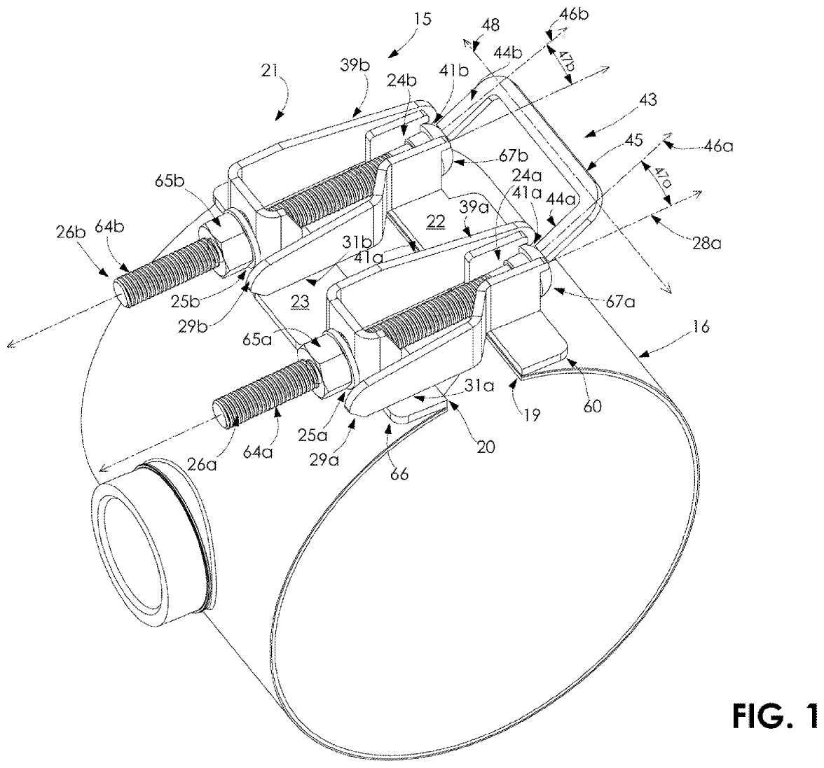

An improved repair clamp and gasket assembly is provided, of which a first embodiment is generally indicated at 15. As shown in FIG. 1, assembly 15 generally comprises band 16, which has two longitudinally extending opposed edges 19 and 20 and in operation is circumferentially disposed on the outside of a pipe or fluid conduit 17, and connecting assembly 21, which in operation spans the gap between edges 19 and 20 of band 16 and is used to draw edges 19 and 20 together. Connecting assembly 21 is attached to band 16 at connections near or proximate to longitudinally extending edges 19 and 20 of band 16, respectively.

As shown, band 16 is a thin semi-cylindrical metal member configured and arranged to be tightened around pipe 17 with connection assembly 21. Band 16 has two longitudinally extending opposed edges 19 and 20.

As shown, a specially configured lug 22 is welded to band 16 proximate to longitudinally extending edge 19, which is parallel to longitudinal axis x-x. Similarly, a specially configured lug 23 is welded to band 16 proximate to longitudinally extending edge 20, which is parallel to longitudinal axis x-x.

Lug element 22 generally comprises lug base element 60 welded to edge 19 of band 16. Base attachment portion 60 includes a plurality of longitudinally spaced bolt receiving slots or grooves 24a and 24b in the top of base 60 extending from the left side to the right side thereof. Fingers 29a and 29b are spaced longitudinally along base 60 of lug 22 and extend transversely towards lug 23 therefrom. Lands 41a and 41b are alternately spaced longitudinally along base 60 of lug 22 with fingers 29a and 29b.

Lug element 23 generally comprises lug base element 66 welded to edge 20 of band 16. Base attachment portion 66 includes a plurality of longitudinally spaced bolt hole openings 25a and 25b extending from the left side to the right side thereof. Fingers 39a and 39b are spaced longitudinally along base 66 of lug 23 and extend transversely toward lug 22 therefrom. Lands 31a and 31b are alternately spaced longitudinally along base 66 of lug 23 with fingers 39a and 39b.

Base 60 of lug 22 and base 66 of lug 23 provide the necessary clearance outside of band 16 and conduit 17 for bolts 26a and 26b. Bolts 26a and 26b comprise bolt heads 67a and 67b and threaded shanks 64a and 64b orientated about center bolt axis 28a and 28b, respectively. Bolt heads 67a and 67b abut against the left side of slots 24a and 24b and extend between lugs 22 and 23. Corresponding washers and nuts 65a and 65b are tightened on the threaded shank portions 64a and 64b of bolts 26a and 26b that extend through to the right side of openings 25a and 25b in lug 23, respectively, to draw opposed lug elements 22 and 23 together, thereby tightening band 16 to pipe 17.

In this embodiment, lugs 22 and 23 are forged, extruded, or molded and formed of a solid unitary piece. However, it is contemplated that lugs 22 and 23 may be cast as separate pieces and then formed together to provide an assembled part. In this embodiment, lug elements 22 and 23 are welded to edges 19 and 20 of band 16, respectively. Alternatively, lugs 22 and 23 may be mechanically connected to band edges 19 and 20. For example, and without limitation, band edges 19 and 20 may each have a longitudinally extending P-shaped end portion and base portions 60 and 66 of lugs 22 and 23 may include a longitudinally P-shaped slot configured and arranged to receive the P-shaped end portions of band 16. The P-shaped end portion of the band edges may thereby be slid into the P-shaped slot in the base of the respective lugs to provide a mechanical connection such that the edges of band 16 move transversely with tightening of connecting assembly 21 and lugs 22 and 23. Other mechanical connections may be used.

Fingers 29a and 29b of lug 22, upon assembly around conduit 17 and tightening of connecting assembly 21, contact and slide over the opposing lands 31a and 31b of lug 23 as the gap between band edge 19 and band edge 20 is closed or reduced by the tightening of connecting assembly 21. Similarly, fingers 39a and 39b of lug 23, upon assembly around conduit 17 and tightening of connecting assembly 21, contact and slide over the opposing lands 41a and 41b of lug 22 as the gap between band edge 19 and band edge 20 is closed or reduced by the tightening of connecting assembly 21. The shape or profile of the bearing surfaces of fingers 29a and 29b and opposed lands 31a and 31b, as well as fingers 39a and 39b and opposed lands 41a and 41b, such as the shape, height, width, length, lateral position, curvature, or tilt, may be changed to accommodate differing clamp geometry requirements. These changes may be made in order to optimize the rise, dwell, fall, heights, and durations depending on repair clamp diameter range requirements. This applies with respect to both the bearing surfaces of lug fingers 29a and 29b and the bearing surfaces of lands 31a and 31b, as well as the bearing surfaces of lug fingers 39a and 39b and the bearing surfaces of lands 41a and 41b.

As shown, assembly 15 includes grip bar or handle 43, which extends longitudinally between bolt heads 67a and 67b of bolts 26a and 26b. As shown, handle 43 comprises left side bar portion 44a, which is orientated about axis 46a and extends from bolt head 67a, and right side bar portion 44b, which is orientated about axis 46b and extends from bolt head 67b, and cross rod 45, which is orientated about axis 48 parallel to axis x-x and extends longitudinally between the outer ends of side bar portions 44a and 44b. As shown, left side bar portion 44a is connected at first end 49a to bolt head 67a and is connected at a second end to a first end of cross rod 45. In this embodiment, axis 46a of side bar portion 44a is angled from bolt axis 28a by offset angle 47a. Angle 47a may be between about 1 and about 89 degrees. In certain embodiments angle 47a is preferably between about 20 and about 45 degrees, and in this embodiment angle 47a is about 30 degrees. Similarly, right side bar portion 44b is connected at first end 49b to bolt head 67b and is connected at a second end to a second end of cross rod 45. In this embodiment, axis 46b of side bar portion 44b is angled from bolt axis 28b by offset angle 47b. Angle 47b may be between about 1 and about 89 degrees. In certain embodiments angle 47b is preferably between about 20 and 45 degrees, and in this embodiment angle 47b is about 30 degrees. Handle 43 allows for quicker and easier application of the clamp assembly, keeps bolts 26a and 26b from rotating about axis 28a and 28b relative to lugs 22 and 23 when nuts 65a and 65b are tightened on threaded shank portions 64a and 64b of bolts 26a and 26b under an applied tightening torque, respectively, and reduces deformation of the clamp assembly under an applied tightening torque.

In this embodiment, handle 43 is forged, extruded, or molded and formed of a solid unitary piece. However, it is contemplated that handle 43 may be cast as separate pieces and then formed together to provide an assembled part. In this embodiment, first ends 49a and 49b of side bar portions 44a and 44b of handle 43 are welded to heads 67a and 67b of bolts 26a and 26b, respectively. Alternatively, first ends 49a and 49b of side bar portions 44a and 44b may be mechanically connected to heads 67a and 67b of bolts 26a and 26b and such connection may be a removable connection. In another alternative, handle 43 may be cast as part of bolts 26a and 26b.

While this embodiment discloses a single panel pipeline repair clamp configuration, the clamp assembly may be used in other configurations or for other purposes. For example, and without limitation, the clamp assembly may be configured for use in a pipeline saddle clamp, a pipeline tapping saddle, a pipeline tapping sleeve and a multi-paneled pipeline repair clamp. Furthermore, assembly 15 may include a spanner, which in operation extends circumferentially across the gap between edges 19 and 20 of band 16, and a gasket, which in operation is disposed between the subject pipe and band 16. The gasket may be a flexible elastomeric matte gasket sheet having specially contoured sealing features and which is disposed between the inner surfaces of band 16 and the outer cylindrical surface of the subject pipe. Thus, the gasket is sandwiched between the inside semi-cylindrical surfaces of band 16 and the outside cylindrical surface of the subject conduit to provide sufficient sealing force to prevent leakage of fluid. Elastic or sealing energy is imparted into assembly 15 by tightening connecting assembly 21 from a loosened or a non-actuated position to a tightened sealed position. The spanner may be a metallic strip that spans the arc-shaped gap between opposed longitudinally extending edges 19 and 20 of band 16. The spanner is designed to compress the gasket across the gap between longitudinally extending edges 19 and 20 of band 16.

The present invention contemplates that many changes and modifications may be made. Therefore, while forms of the improved clamp assembly have been shown and described, and a number of alternatives discussed, persons skilled in this art will readily appreciate that various additional changes and modifications may be made without departing from the scope of the invention, as defined and differentiated by the following claims.

1. A clamp assembly comprising:
a band configured to clamp on to a fluid conduit oriented about a longitudinally extending axis;
said band comprising a first longitudinally extending edge and a second longitudinally extending edge;
a connecting assembly operatively configured to tighten said band to said fluid conduit from a non-actuated position to a tightened position;
said connecting assembly comprising a first lug element connected proximate to said first longitudinally extending edge of said band and a second lug element connected proximate to said second longitudinally extending edge of said band;
said first lug element comprising multiple longitudinally spaced bolt receiving openings;
said second lug element comprising multiple longitudinally spaced bolt receiving openings;
multiple lug bolts extending transversely between said first lug element and said second lug element, each of said lug bolts orientated about a central bolt axis and extending from one of said bolt receiving openings in said first lug element to one of said bolt receiving openings in said second lug element; and
a handle extending longitudinally between at least two of said transversely extending lug bolts.

2. A clamp assembly set forth in claim 1, wherein said multiple lug bolts comprise a first lug bolt having a first head portion and a first shank portion, and a second lug bolt having a second head portion and a second shank portion.

3. A clamp assembly set forth in claim 2, wherein said handle extends from said first head portion of said first lug bolt to said second head portion of said second lug bolt.

4. The clamp set forth in claim 3, wherein said handle extends from said first head portion of said first lug bolt at a first angle offset from a first central axis of said first lug bolt and extends from said second head portion of said second lug bolt at a second angle offset from a second central axis of said second lug bolt.

5. A clamp assembly set forth in claim 4, wherein said handle is welded to said first head portion of said first lug bolt and said second head portion of said second lug bolt.

6. A clamp assembly set forth in claim 3, wherein said handle comprises a longitudinally extending rod portion.

7. A clamp assembly set forth in claim 3, wherein said handle is connected to said first head portion of said first lug bolt via a weld connection or a mechanical connection.

8. A clamp assembly set forth in claim 7, wherein said handle is connected to said second head portion of said second lug bolt via a weld connection or a mechanical connection.

9. The clamp set forth in claim 1, wherein said bolt receiving openings in said first lug element comprise an open slot and said bolt receiving openings in said second lug element comprise a cylindrical through-bore.

10. The clamp set forth in claim 1, wherein:
said first lug element comprising multiple longitudinally spaced and transversely extending lug fingers;
said second lug element comprising multiple longitudinally spaced lug finger lands; and
each of said lug fingers of said first lug element extending transversely between said first lug element and said second lug element such that each of said lug fingers of said first lug element bear against one of said lug finger lands of said second lug element.

11. The clamp set forth in claim 10, wherein:
said second lug element comprises multiple longitudinally spaced and transversely extending lug fingers;
said first lug element comprises multiple longitudinally spaced lug finger lands; and
each of said lug fingers of said second lug element extending transversely between said second lug element and said first lug element such that each of said lug fingers of said second lug element bear against one of said lug finger lands of said first lug element.

12. The clamp set forth in claim 1, wherein said first lug element is connected to said band proximate to said first longitudinally extending edge of said band via a weld connection or a mechanical connection and said second lug element is connected to said band proximate to said second longitudinally extending edge of said band via a weld connection or a mechanical connection.
